(19) United States
(12) Patent Application Publication
(10) Pub. No.: US 2025/0045093 A1
(43) Pub. Date: Feb. 6, 2025

(54) TASK EXECUTION METHOD AND APPARATUS, AND DEVICE AND MEDIUM

(71) Applicant: Beijing Zitiao Network Technology Co., Ltd., Beijing (CN)

(72) Inventor: Shuai WANG, Beijing (CN)

(21) Appl. No.: 18/720,010

(22) PCT Filed: Dec. 7, 2022
(86) PCT No.: PCT/CN2022/137230

§ 371 Date: Jun. 14, 2024

(30) Foreign Application Priority Data
Dec. 15, 2021 (CN) 202111539442.X

(51) Int. Cl. G06F 9/48

(52) U.S. Cl. CPC G06F 9/4843

(57) ABSTRACT

A task execution method and apparatus, and a device and a medium. The method is applied to a target device configured with a GPU. The method includes: obtaining a configuration file in response to receiving an execution instruction for a specified task, wherein the specified task is a task executed based on the GPU, and the configuration file includes a mapping relationship between a device category and a preferred GPU sub-thread number; determining a target device category to which the target device belongs based on the configuration file; and executing the specified task by using the preferred GPU sub-thread number corresponding to the target device category.

### CROSS-REFERENCE TO RELATED APPLICATIONS

The present application is based on and claims priority to China Patent Application No. 202111539442.X filed on Dec. 15, 2021, the disclosure of which is incorporated by reference herein in its entirety.

### TECHNICAL FIELD

The present disclosure relates to the technical field of computers, in particular to a task execution method and apparatus, a device, and a medium.

### BACKGROUND

Many devices such as mobile terminals, desktop terminals are usually provided with a GPU (Graphics Processing Unit). In some scenarios, parameters required for executing specified tasks such as image rendering may involve a GPU sub-thread number. The GPU sub-thread number, also known as local work size, specifically refers to the number of corresponding sub-threads in a same thread bundle.

### SUMMARY

An embodiment of the present disclosure provides a task execution method applied to a target device configured with a graphics processing unit (GPU), the task execution method comprising: obtaining a configuration file in response to receiving an execution instruction for a specified task, wherein the specified task is a task executed based on the GPU, and the configuration file comprises a mapping relationship between a device category and a preferred GPU sub-thread number, wherein the preferred GPU sub-thread number is number of a sub-thread of the GPU used by a representative device in the device category taking shortest time to execute the specified task based on the GPU of the representative device; determining a target device category to which the target device belongs based on the configuration file; and executing the specified task by using the preferred GPU sub-thread number corresponding to the target device category.

In some embodiments, the configuration file is recorded with device identifiers of a plurality of devices corresponding to each device category; and the determining of the target device category to which the target device belongs based on the configuration file comprises: searching for the device category corresponding to a device identifier of the target device in the configuration file, and using the device category searched as the target device category to which the target device belongs.

In some embodiments, the configuration file is recorded with a categorization method of the device category, the categorization method comprising categorization by a GPU manufacturer name or categorization by a GPU model; and the determining of the target device category to which the target device belongs based on the configuration file comprises: determining the target device category to which the target device belongs based on the categorization method of the device category recorded in the configuration file and GPU information of the target device.

In some embodiments, the GPU information comprises the GPU manufacturer name or the GPU model.

In some embodiments, all devices corresponding to a device category have a specific GPU commonality, and different device categories correspond to different GPU commonalities.

In some embodiments, the configuration file is generated by: obtaining GPU information of a plurality of devices, wherein each of the plurality of devices is configured with a GPU; categorizing the plurality of devices into a plurality of device categories based on the GPU information, each device category of the plurality of device categories corresponding to a plurality of devices; for the each device category, selecting a representative device from all devices corresponding to the each device category, obtaining the preferred GPU sub-thread number corresponding to the representative device of the each device category, and using the preferred GPU sub-thread number as the preferred GPU sub-thread number corresponding to the each device category; and generating the configuration file based on the mapping relationship between the each device category and the preferred GPU sub-thread number.

In some embodiments, the obtaining of the preferred GPU sub-thread number corresponding to the representative device of the each device category comprises: obtaining a plurality of candidate GPU sub-thread numbers; for each of the plurality of candidate GPU sub-thread numbers, using the each of the plurality of candidate GPU sub-thread numbers as a parameter for a preset open computing language OpenCL program, and obtaining time consumption for the representative device of the each device category to adopt the preset OpenCL program to execute the specified task; and using a candidate GPU sub-thread number corresponding to shortest time consumption as the preferred GPU sub-thread number corresponding to the representative device of the each device category.

In some embodiments, the GPU information comprises a GPU manufacturer name; and the categorizing of the plurality of devices into the plurality of device categories based on the GPU information comprises: categorizing the plurality of devices into a plurality of manufacturer categories based on the GPU manufacturer name of each of the plurality of devices, wherein all devices corresponding to each of the plurality of manufacturer categories have a same manufacturer name.

In some embodiments, the GPU information comprises a GPU model; and the categorizing of the plurality of devices into the plurality of device categories based on the GPU information comprises: categorizing the plurality of devices into a plurality of GPU model categories based on the GPU model of each of the plurality of devices, wherein all devices corresponding to each of the plurality of GPU model categories have a same GPU model.

In some embodiments, the selecting of the representative device from all devices corresponding to the each device category comprises: obtaining index data of each of the plurality of devices corresponding to the each device category based on a preset measurement index, wherein the preset measurement index comprises a market coverage rate and/or device performance; and selecting the representative device from all the devices corresponding to the each device category based on the index data of the each of the plurality of devices.

In some embodiments, the selecting of the representative device from all the devices corresponding to the each device category based on the index data of the each of the plurality of devices comprises: selecting a most typical device from all the devices corresponding to the each device category as the representative device by comparing the index data of the plurality of devices.

In some embodiments, the selecting of the representative device from all the devices corresponding to the each device category based on the index data of the each of the plurality of devices comprises: determining a median value of the index data of all the devices corresponding to the each device category based on the index data of the each of the plurality of devices; and selecting a device, of which index data is closest to the median value, from all the devices corresponding to the each device category, and using the device selected as the representative device of the each device category.

An embodiment of the present disclosure provides a task execution apparatus applied to a target device configured with a GPU, the task execution apparatus comprising: a file obtaining module configured to obtain a configuration file in response to receiving an execution instruction for a specified task, wherein the specified task is a task executed based on the GPU, and the configuration file comprises a mapping relationship between a device category and a preferred GPU sub-thread number, wherein the preferred GPU sub-thread number is number of a sub-thread of the GPU used by a representative device in the device category taking shortest time to execute the specified task based on the GPU of the representative device; a category determination module configured to determine a target device category to which the target device belongs based on the configuration file; and a task execution module configured to execute the specified task by using the preferred GPU sub-thread number corresponding to the target device category.

An embodiment of the present disclosure provides an electronic device, comprising: a processor; and a memory configured to store executable instructions for the processor; wherein the processor is configured to read the executable instructions from the memory and execute the executable instructions to implement the task execution method provided in the embodiments of the present disclosure.

An embodiment of the present disclosure further provides a computer-readable storage medium on which a computer program is stored, wherein the computer program is configured to perform the task execution method provided in the embodiments of the present disclosure.

An embodiment of the present disclosure further provides a computer program, comprising: instructions that, when executed by a processor, cause the processor to perform the task execution method provided in the embodiments of the present disclosure.

It should be understood that the contents described in this section are not intended to identify critical or important features of the embodiments of the present disclosure, nor are they intended to be used to limit the scope of the present disclosure. Other features of the present disclosure will be readily understood through the following description.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the technical solutions in the embodiments of the present disclosure or in the prior art, a brief introduction will be given below for the drawings required to be used in the description of the embodiments or the prior art. It is obvious that, for a person skilled in the art, he or she may also acquire other drawings according to such drawings on the premise that no inventive effort is involved.

FIG. 1 is a flowchart of a task execution method provided by an embodiment of the present disclosure;

FIG. 2 is a schematic flowchart of a method for generating a configuration file provided by an embodiment of the present disclosure;

FIG. 3 is a schematic flowchart of a method for generating a configuration file provided by an embodiment of the present disclosure;

FIG. 4 is a schematic structure diagram of a task execution apparatus provided by an embodiment of the present disclosure;

FIG. 5 is a schematic structure diagram of an electronic device provided by an embodiment of the present disclosure.

### DETAILED DESCRIPTION

In order to better understand the above objects, features and advantages of the present disclosure, the solution of the present disclosure will be further described below. It should be noted that, in the case of no conflict, the embodiments of the present disclosure and the features in the embodiments may be combined with each other.

Many specific details are set forth in the following description to facilitate a full understanding of the present disclosure, but the present disclosure can also be implemented in ways different from those described herein. Obviously, embodiments described in the description are only some embodiments of the present disclosure, and are not all of embodiments thereof.

The inventor of the present disclosure has found through research that the GPU sub-thread number can affect the efficiency of task execution, such as affecting task time consumption. However, because there are many kinds of devices configured with GPU in the market, (for example, there are thousands of models of mobile phones), it is difficult and costly to determine the appropriate GPU sub-thread number for each device type. Therefore, the straightforward way of having each device execute a task with a uniform default GPU sub-thread number can result in poor task execution effect.

Specifically, the inventor of the present disclosure has found through research that the GPU sub-thread number (i.e. local work size) can affect the performance of the GPU in executing specified tasks such as image rendering. The GPU sub-thread number is also a core parameter of OpenCL (Open Computing Language). The GPU focuses on executing highly threaded parallel processing tasks, while OpenCL is a universal parallel computing language that supports a variety of devices with a GPU, comprising mobile and desktop devices. In other words, OpenCL can widely support different types of GPUs, and the GPU sub-thread number has a significant impact on the performance of OpenCL, such as 10%-70% of its performance, mainly reflected in the impact on task execution effect. Specifically, the task execution effect is mainly reflected in the task execution time. For example, an inappropriate GPU sub-thread number will directly increase the time required to execute a given task using OpenCL. Therefore, it is desirable to find a preferred GPU sub-thread number for each device type. However, there are many kinds of devices configured with a GPU in the market (for example, there are thousands of models of mobile phones), finding a preferred GPU sub-thread number for each device requires a lot of work and is highly unrealistic. In related art, a unified default GPU sub-thread number is used for most devices to execute a task, and the task execution effect needs to be improved.

In view of this, embodiments of the present disclosure provide a task execution method and apparatus, a device, and a medium, which will be discussed in detail below for easy understanding.

In addition, the defects in the related art are also the results obtained by the applicant after practice and careful study. Therefore, the discovery process of the above defects and the solution proposed in the embodiments of the application for the above defects in the following description should be recognized as contributions made by the applicant to the application.

FIG. 1 is a flowchart of a task execution method provided by an embodiment of the present disclosure. The method is applied to a target device configured with a GPU. For example, the target device is a mobile terminal such as a mobile phone, a computer, etc. As shown in FIG. 1, the method mainly comprises the following steps S102 to S106.

In step S102, a configuration file is obtained in response to receiving an execution instruction for a specified task. The specified task is a task executed based on the GPU. The configuration file comprises a mapping relationship between a device category and a preferred GPU sub-thread number, wherein the preferred GPU sub-thread number is number of a sub-thread of the GPU used by a representative device in the device category taking shortest time to execute the specified task based on the GPU of the representative device. The above device category is a category to which the device belongs.

The above specified task may be an image rendering task. In a specific example, considering the wide applicability of OpenCL to GPU, the specified task may be a task executed by an OpenCL program. The embodiments of the present disclosure does not limit the specific specified task. For example, any task executed based on OpenCL can be used as the specified task. A execution instruction for the specified task described above can be directly initiated by a user, or automatically initiated by a system/platform associated with the specified task as needed.

In some implementations, the target device can obtain the configuration file in a specified manner. When downloading the configuration file in a specified manner, the configuration file can be automatically downloaded based on a user setting when the specified task is executed, or users can be prompted to download the configuration file themselves. A user can also directly import the configuration file to a target device and store the configuration file at a specified location. On the basis of the above, the target device can directly read the configuration file from the specified location after receiving the execution instruction for the specified task. In other implementations, the target device downloads the configuration file in the specified manner described above after receiving the execution instruction for the specified task.

The above configuration file can be generated in advance and mainly comprises the mapping relationship (also known as correspondence relationship) between a device category and a preferred GPU sub-thread number. Specifically, the configuration file comprises a plurality of device categories, each device category corresponding to one preferred GPU sub-thread number. In an embodiment of the present disclosure, the plurality of devices configured with GPUs can be categorized into a plurality of device categories, each device category corresponding to a plurality of devices. All devices corresponding to each device category have a specific GPU commonality, and different device categories correspond to different GPU commonalities. In some implementations, the configuration file comprises not only the mapping relationship between the device category and the preferred GPU sub-thread number, but also device identifiers of all devices in each device category. In other implementations, in addition to the mapping relationship between the device category and the preferred GPU sub-thread number, the configuration file further comprises a categorization method of the device category. For example, if a plurality of device categories is categorized by CPU manufacturers, each device category corresponds to a name of a GPU manufacturer, and if a plurality of device categories are categorized by GPU models, each device category corresponds to a GPU model.

the preferred GPU sub-thread number corresponding to each device category in the above configuration file is number of a sub-thread of the GPU used by a representative device in the device category taking shortest time to execute the specified task based on its GPU (i.e., the GPU of that representative device). Then, the preferred GPU sub-thread number corresponding to the representative device is used as the preferred GPU sub-thread number corresponding to the device category, that is, as the preferred GPU sub-thread number corresponding to all devices in the device category. Considering that there are many kinds of devices configured with a GPU, it is costly to determine an appropriate GPU sub-thread number for each device. Therefore, in the configuration file provided in the embodiment of the present disclosure, a plurality of devices are categorized into a plurality of categories. For each category, a representative device is selected, and it is only required to determine a preferred GPU sub-thread number corresponding to the representative device. The preferred GPU sub-thread number corresponding to the representative device is used as the preferred GPU sub-thread number corresponding to the device category, which is more feasible, and can be achieved at a lower cost.

In some implementations, the representative device corresponding to a device category can be a most typical device among all devices in the device category. For example, a mid-range device in a device category may be used as a representative device. In practical applications, a representative device can be manually specified for each device category. Alternatively, device information of all devices in each device category can be obtained. Through device information comparison, a device that meets a preset rule can be automatically selected as the representative device. The preset rule can be set according to needs. For example, a device with a mid-range GPU performance parameter among all devices in a device category can be used as a representative device. In some implementations, the representative device may execute a preset OpenCL program to traverse a plurality of GPU sub-thread numbers (such as all possible thread numbers that can be enumerated) to find a least time-consuming GPU sub-thread number, and the found thread number is used as the preferred GPU sub-thread number of the representative device.

In step S104, a target device category to which the target device belongs is determined based on the configuration file.

In some embodiments, the configuration file is recorded with device identifiers of a plurality of devices corresponding to each device category. In this case, in the configuration file, the device category corresponding to a device identifier of the target device can be searched for, and the device category searched is used as the target device category to which the target device belongs. For example, there are three device categories in the configuration file (category A, category B and category C), with device identifiers a1, a2, a3˜a85 belonging to category A, device identifiers b1, b2, b3˜b70 belonging to category B, and device identifiers c1, c2, c3˜c121 belonging to category C, and if the device identifier of the target device is b35, then a device category corresponding to the target device is the category B.

In some embodiments, the configuration file is recorded with a categorization method of the device category. The categorization method comprises categorization by a GPU manufacturer name or categorization by a GPU model. In this case, the target device category to which the target device belongs can be determined based on the categorization method of the device category recorded in the configuration file and GPU information of the target device. For example, if the configuration file comprises three device categories categorized by a GPU manufacturer name, category A corresponding to manufacturer A, category B corresponding to manufacturer B, and category C corresponding to manufacturer C, and if the GPU information of the target device shows that the manufacturer of the target device is A, then the device category corresponding to the target device is category A.

The above are only illustrative and should not be considered as a limitation.

In step S106, the specified task is executed by using the preferred GPU sub-thread number corresponding to the target device category.

It can be understood that due to the commonality of devices in the same device category, the target device usually takes less time to execute a task using the preferred GPU sub-thread number corresponding to the representative device in the device category. Compared to a default GPU sub-thread number, the above method is easy to implement and can effectively improve the task execution effect.

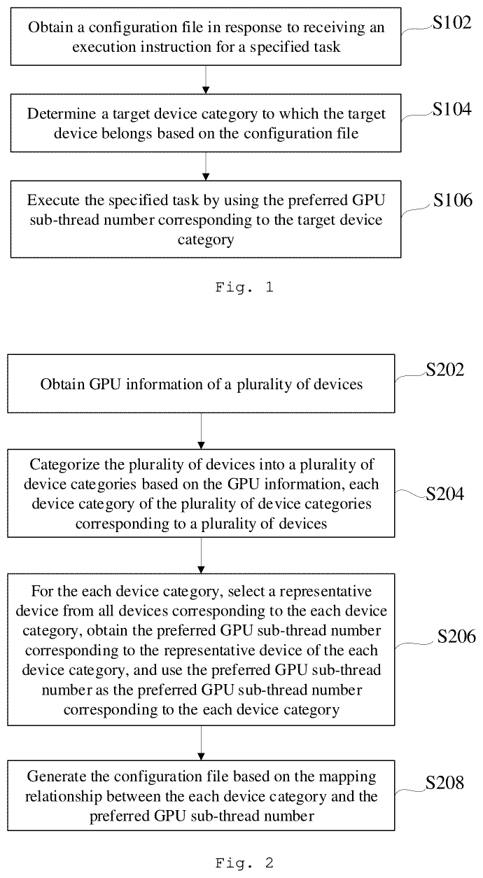

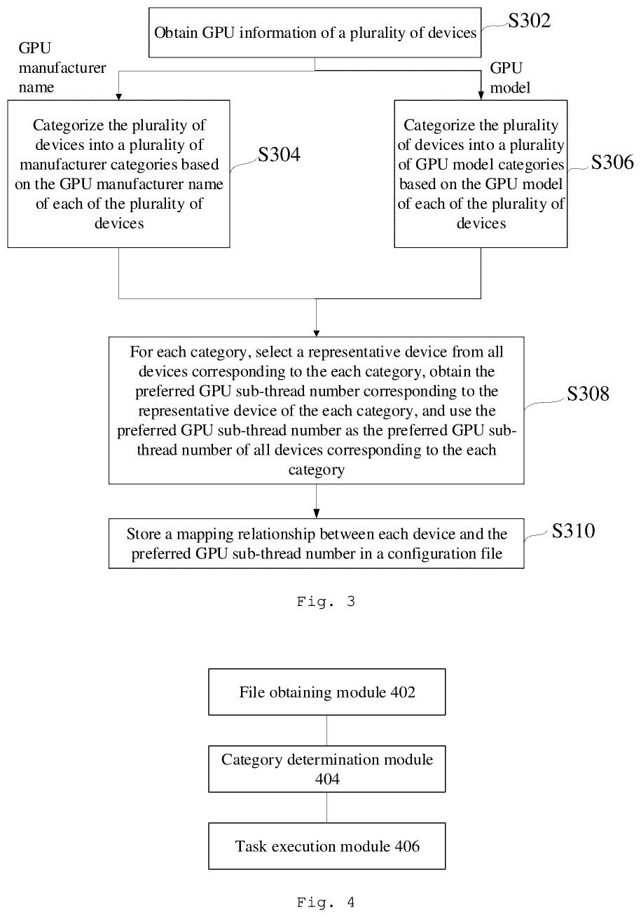

Heretofore, a task execution method according to some embodiments of the present disclosure is provided. In the method, a target device configured with a GPU can obtain a configuration file in response to receiving an execution instruction for a specified task, wherein the configuration file comprises a mapping relationship between a device category and a preferred GPU sub-thread number, wherein the preferred GPU sub-thread number is number of a sub-thread of the GPU used by a representative device in the device category taking shortest time to execute the specified task based on the GPU of the representative device; then determine a target device category to which the target device belongs based on the configuration file; and execute the specified task by using the preferred GPU sub-thread number corresponding to the target device category. The above method can obtain a configuration file that is recorded with the mapping relationship between a device category and a preferred GPU sub-thread number when executing a specified task, and execute the specified task by using a preferred GPU sub-thread number corresponding to a target device category to which a target device belongs, the preferred GPU sub-thread number corresponding to the target device category being a GPU sub-thread number used by a representative device in the device category to execute the specified task with the shortest time. Due to devices in the same device category usually have a commonality, the time required for the target device to execute the task using the preferred GPU sub-thread number corresponding to the representative device in the device category is usually shorter. Compared to a default GPU sub-thread number, the above method is easy to implement and can effectively improve task execution effect. On the basis of above, an embodiment of the present disclosure further provides a method for generating a configuration file. FIG. 2 is a schematic flowchart of a method for generating a configuration file provided by an embodiment of the present disclosure. The method comprises the following steps S202 to S208.

In step S202, GPU information of a plurality of devices is obtained. Each of the plurality of devices is configured with a GPU.

In practical applications, the number of categories of the above-mentioned devices can be set according to requirements, and there is no restriction here. For example, based on mainstream devices such as mobile phones and computers in the current market, GPU information corresponding to various device models popular in the market for a certain period of time (such as the last 5 years) can be obtained. It is also possible to obtain GPU information for all available devices on the network or in the market. In some embodiments, the GPU information comprises a GPU manufacturer name or a GPU model. The GPU manufacturer name can be, for example, Qualcomm, Mali, and PowerVR, or the like, and the GPU model can be, for example, Mali G77, Mali G76, Adreno510, or the like.

In step S204, the plurality of devices are categorized into a plurality of device categories based on the GPU information, each device category of the plurality of device categories corresponding to a plurality of devices.

Since each device corresponds to GPU information, the devices can be categorized into a plurality of device categories based on GPU information, wherein each device category corresponds to a plurality of devices. All devices corresponding to each device category have a specific GPU commonality, and different device categories correspond to different GPU commonalities. For example, in some embodiments, although there are many devices, each of which is configured with a GPU, there are currently few GPU manufacturers, and many devices adopt GPUs produced by the same manufacturer. Therefore, the plurality of devices can be categorized into a plurality of categories based on GPU manufacturers. For another example, the existing number of GPU models is far less than the number of device types. Some devices adopt the same GPU model. Therefore, the plurality of devices can be categorized into a plurality of categories based on GPU models.

In step S206, for the each device category, a representative device is selected from all devices corresponding to the each device category, the preferred GPU sub-thread number corresponding to the representative device of the each device category is obtained, and the preferred GPU sub-thread number is used as the preferred GPU sub-thread number corresponding to the each device category. That is, the preferred GPU sub-thread number corresponding to the representative device in the device category is used as the preferred GPU sub-thread number corresponding to all devices in the device category. The preferred GPU sub-thread number is a GPU sub-thread number used by the GPU of the representative device to execute the specified task with the shortest time consumption. Since the task execution effect is mainly reflected in the aspect of task time consumption, the embodiment of the present disclosure can determine whether a GPU sub-thread number is optimal based on the time consumption of executing the specified task. In some embodiments, it is possible to exhaustively enumerate all possible GPU sub-thread numbers and then make the representative device execute the specified task using each of the possible GPU sub-thread numbers, determine the corresponding time consumption for each GPU sub-thread number, and use the GPU sub-thread number with the shortest time consumption as the preferred GPU sub-thread number of the representative device, which can also be referred to as the optimal GPU sub-thread number of the representative device.

Due to the device categorization based on the GPU information of the various devices in the above step, all devices corresponding to each category actually have a certain GPU commonality. For example, for the category categorized by a GPU manufacturer or the category categorized by a GPU model, there is little difference between the GPUs of all devices in the same category. In most cases, some characteristics of the GPUs are changed and improved, and most characteristics are still the same. Therefore, for each category, the preferred GPU sub-thread number of the representative device is also the preferred GPU sub-thread number for other devices in the same category to some extent. Although not necessarily the most optimal, compared to a unified default GPU sub-thread number, the task execution effect is better because it is closer to the device's own GPU characteristics, and the required time is usually lower than the required time achieved with a unified default GPU sub-thread number.

In step S208, the configuration file is generated based on the mapping relationship between the each device category and the preferred GPU sub-thread number. Specifically, the mapping relationship (correspondence relationship) between each device category and the preferred GPU sub-thread number can be recorded in a file that can be used as a configuration file.

In practical applications, the configuration file can be published in a manner such as over a network. When each device executes a specified task that requires the GPU sub-thread number with the GPU, the configuration file can be obtained by network download, data import, etc., and then a preferred GPU sub-thread number corresponding to the device is searched from the configuration file. In some embodiments, the configuration file can be a large file that records a preferred GPU sub-thread number corresponding to each category and a device identifier (device model) corresponding to each category. All devices in the same category correspond to the same preferred GPU sub-thread number. In other implementations, the configuration file may comprise a plurality of subfiles, each of which records the preferred GPU sub-thread number corresponding to a category and a device identifier in the category. After obtaining the configuration file, the target device can directly search for its corresponding preferred GPU sub-thread number from the configuration file based on its own identifier. Many existing devices can obtain their corresponding preferred GPU sub-thread numbers through the configuration file. Thus, the configuration file is compatible with different device models, and automatic model matching can be achieved for different devices by reading the configuration file.

In the method for generating the configuration file provided in the embodiment of the present disclosure, since the categories are categorized according to the GPU information, and the devices corresponding to each category usually have a certain number GPU sub-thread used by the GPU commonality, the representative device to execute a specified task with the shortest time consumption (the preferred GPU sub-thread number of the representative device) can also be used as a preferred GPU sub-thread number for other devices in the category. That is, a preferred GPU sub-thread number corresponding to each device can be obtained accordingly. Compared to using a default GPU sub-thread number in the related art, the above method provided in the embodiment of the present disclosure can conveniently and quickly obtain the preferred GPU sub-thread number corresponding to each device and record the preferred GPU sub-thread number in the configuration file, thereby assisting to improve the task execution effect of each device at a later time. In addition, since the embodiment of the present disclosure is to obtain the preferred GPU sub-thread number of the representative device of each category, it is more feasible and requires less cost as compared to the method of separately obtaining preferred GPU sub-thread numbers for a large number of devices.

An embodiment of the present disclosure illustrates the method of categorizing a plurality of devices into a plurality of device categories based on GPU information, wherein the device categories are manufacturer categories or GPU model categories, which can be implemented in manners (1) and (2) below.

(1) If the GPU information is GPU manufacturer names, the plurality of devices are categorized into a plurality of manufacturer categories based on the GPU manufacturer name of each of the plurality of devices, wherein all devices corresponding to each of the plurality of manufacturer categories have a same manufacturer name. For example, taking the Android mobile devices as an example, they can be mainly categorized into three major manufacturers: Qualcomm, Mali and PowerVR. It can be understood that there are relatively few existing GPU manufacturers, so the plurality of devices can be roughly categorized into a plurality of manufacturer categories. For example, devices using GPUs manufactured by Qualcomm belong to the Qualcomm category, and devices using GPUs manufactured by Mali belong to the Mali category.

That is to say, in some embodiments, the GPU information comprises a GPU manufacturer name; and the categorizing of the plurality of devices into the plurality of device categories based on the GPU information comprises: categorizing the plurality of devices into a plurality of manufacturer categories based on the GPU manufacturer name of each of the plurality of devices, wherein all devices corresponding to each of the plurality of manufacturer categories have a same manufacturer name.

(2) If the GPU information is GPU models, the plurality of devices are categorized into a plurality of GPU model categories based on the GPU model of each of the plurality of devices, wherein all devices corresponding to each of the plurality of GPU model categories have a same GPU model. It can be understood that although there are many existing devices, many of them use the same GPU model, so the plurality of devices can be finely categorized into a plurality of GPU model categories.

That is to say, in some embodiments, the GPU information comprises a GPU model; and the categorizing of the plurality of devices into the plurality of device categories based on the GPU information comprises: categorizing the plurality of devices into a plurality of GPU model categories based on the GPU model of each of the plurality of devices, wherein all devices corresponding to each of the plurality of GPU model categories have a same GPU model.

It can be understood that the above method (1) is a coarse-grained categorization method. For example, there are only three or four mainstream manufacturers, resulting in a correspondingly smaller number of categories. The above method (2) is a fine-grained categorization method. For example, there are about 50 mainstream GPU models, which results in a larger number of categories, but still far less than the number of several thousands of devices. In practical applications, the above method (1) or (2) can be flexibly selected according to needs. For example, if there are no high time consumption requirements for executing the specified task on a GPU, the method (1) can simply be used. If there are high time consumption requirements, the method (2) above can be used for categorization. The above is only an example and should not be considered as a limitation. In practical applications, it is also possible to perform categorization according to a series of categories under the same GPU manufacturer based on GPU information, such as Mali 5 category, Mali 6 category, etc.

After the categorization of the plurality of device categories, for each device category, a representative device can be selected from all the devices corresponding to the device category, which can be achieved, for example, in the following steps 1 and 2.

In step 1, index data of each of the plurality of devices corresponding to the device category is obtained based on a preset measurement index, wherein the preset measurement index comprises a market coverage rate and/or device performance. Market coverage rate, also known as market share, can be determined through network statistics. In some embodiments, device performance can be reflected by the time it takes for a device to execute a task. For example, for the same task, the shorter the time, the better the device performance. In practical applications, because all devices are publicly used in the market, and the performance of the devices are also public parameters, the performance of any device can be easily and directly obtained over the network.

In step 2, the representative device is selected from all the devices corresponding to the device category based on the index data of the each of the plurality of devices.

By comparing the index data of the plurality of devices, the most typical device can be found as the representative device, i.e., the most typical device among all devices in the device category can be used as the representative device. In some embodiments, a mid-range device in each category can be used as the representative device. In this case, a median value of the index data of all the devices corresponding to the category can be determined based on the index data of the each of the plurality of devices; and then a device, of which index data is closest to the median value, is selected from all the devices corresponding to the category, and the device selected is used as the representative device of the category. The device, of which index data is the median (or closest to the median), is the mid-range device. It can be understood that the mid-range device of each category usually has the general characteristics of the category. Those devices in a category, whether low-end devices or high-end devices, have GPU performance that is close to the GPU performance of the mid-range device to some extent. Therefore, the mid-range device can be selected to objectively represent all the devices in the category, and then the preferred GPU sub-thread number of the mid-range device can be used as a preferred GPU sub-thread number corresponding to another device in the same category.

Further, an embodiment of the present disclosure provides a specific method for obtaining a preferred GPU sub-thread number corresponding to the representative device of the device category, which comprises steps a to c below.

In step a, a plurality of candidate GPU sub-thread numbers are obtained. In some embodiments, a plurality of candidate GPU sub-thread numbers can be determined based on an enumeration method, that is, possible GPU sub-thread numbers can be listed in an exhaustive way.

In step b, for each of the plurality of candidate GPU sub-thread numbers, the each of the plurality of candidate GPU sub-thread numbers is used as a parameter for a preset OpenCL program, and time consumption for the representative device of the each device category to adopt the preset OpenCL program to execute the specified task is obtained. Because OpenCL widely supports GPU, a preset OpenCL program can be used to execute a specified task, and the GPU sub-thread number is a necessary parameter for the OpenCL program. Specifically, it is a kernel function parameter of OpenCL that directly affects the performance (time consumption) of OpenCL program to execute the specified task. Therefore, all devices in the embodiment of the present disclosure can execute the specified task using the preset OpenCL program. In practical applications, the time it takes to execute the specified task can be determined using a preset timing method, for example, using the clGetEventProfilingInfo function for timing.

In step c, a candidate GPU sub-thread number corresponding to shortest time consumption is used as the preferred GPU sub-thread number corresponding to the representative device of the each device category.

The candidate GPU sub-thread number corresponding to the shortest time consumption is actually an optimal GPU sub-thread number corresponding to the representative device, which can achieve the best task execution effect compared to other candidate GPU sub-thread numbers. In addition, in practical applications, since the GPU sub-thread number is a kernel function parameter of OpenCL, and there may be multiple kernel functions, the corresponding preferred GPU sub-thread number can be determined for each kernel function. That is, steps a to c are performed for each kernel function, and the final preferred GPU sub-thread number of the representative device comprises preferred GPU sub-thread numbers corresponding to multiple kernel functions.

On the basis of above, an embodiment of the present disclosure further provides a method for generating a configuration file. FIG. 3 is a schematic flowchart of a method for generating a configuration file provided by an embodiment of the present disclosure. The method mainly comprises the following steps S302 to S310.

In step S302, GPU information of a plurality of devices is obtained. Each of the plurality of devices is configured with a GPU. If the GPU information is a GPU manufacturer name, the method proceeds to step S304. If the GPU information is a GPU model, the method proceeds to step S306.

In step S304, the plurality of devices are categorized into a plurality of manufacturer categories based on the GPU manufacturer name of each of the plurality of devices.

In step S306, the plurality of devices are categorized into a plurality of GPU model categories based on the GPU model of each of the plurality of devices.

In step S308, for the each category, a representative device is selected from all devices corresponding to the each category, the preferred GPU sub-thread number corresponding to the representative device of the each category is obtained, and the preferred GPU sub-thread number is used as the preferred GPU sub-thread number of all devices corresponding to the each category.

In step S310, a mapping relationship between each device and the preferred GPU sub-thread number is stored in a configuration file. In this way, the configuration file can be directly provided to a target device that executes a specified task, so that the GPU of the target device can execute the specified task based on the corresponding preferred GPU sub-thread number recorded in the configuration file.

In practical applications, the above steps S304 and S306 can be performed either or both, and two configuration files are generated for different categories, one being a coarse-grained configuration file categorized by a manufacturer name and the other being a fine-grained configuration file categorized by a GPU model. A device can then determine a preferred GPU sub-thread number in which configuration file to be used based on the time requirements of a task to be executed. For example, a preferred GPU sub-thread number in the coarse-grained configuration file can be used for lower time requirements, and a preferred GPU sub-thread number in the fine-grained configuration file can be used for higher time requirements.

For the above steps shown in FIG. 3 and the beneficial effect provided by the embodiment of the present disclosure, reference can be made to the relevant content mentioned above, which will not be repeated here.

In addition, in practical applications, since the GPU is a chip mounted on a graphics card, in some embodiments, a GPU model can be directly equated with a graphics card model. Therefore, in the above-mentioned method provided by the embodiment of the present disclosure, the GPU model involved can also be the graphics card model, such as Adreno graphics card, Mali graphics card, powerVR graphics card, AMD graphics card, Intel graphics card, AMD graphics card, Nvidia graphics card, and so on. OpenCL can widely support different types of GPUs, which can also be said that OpenCL widely supports different types of graphics cards.

In summary, in the above task execution method provided in the embodiment of the present disclosure, a target device configured with a GPU can obtain a configuration file that records the mapping relationship between the device category and the preferred GPU sub-thread number when executing a specified task, and execute the specified task by using a preferred GPU sub-thread number corresponding to a target device category to which the target device belongs, wherein the preferred GPU sub-thread number corresponding to the target device category is a GPU sub-thread number used by a representative device in the device category to execute the specified task with the shortest time consumption. Since devices in the same device category usually have a certain commonality, the target device may take less time to execute a task using the preferred GPU sub-thread number corresponding to the representative device in the device category. Compared to a default GPU sub-thread number, the above method is easy to implement and can effectively improve the task execution effect.

The above method can be well applied to scenarios involving OpenCL (which requires the GPU sub-thread number), effectively improving the task execution performance based on OpenCL. Research has shown that a performance gain of 10%-70% can be achieved.

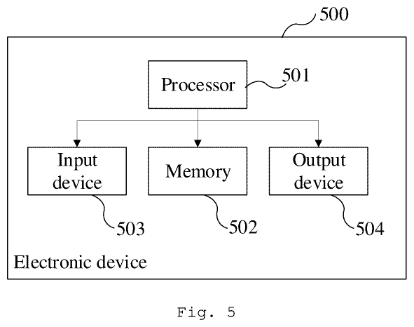

Corresponding to the aforementioned task execution method provided by an embodiment of the present disclosure, an embodiment of the present disclosure provides a task execution apparatus. The apparatus is applied to a target device configured with a GPU. FIG. 4 shows a schematic structure diagram of a task execution apparatus, the task execution apparatus comprising: a file obtaining module 402, a category determination module 404, and a task execution module 406.

The file obtaining module 402 is configured to obtain a configuration file in response to receiving an execution instruction for a specified task, wherein the specified task is a task executed based on the GPU, and the configuration file comprises a mapping relationship between a device category and a preferred GPU sub-thread number, wherein the preferred GPU sub-thread number is number of a sub-thread of the GPU used by a representative device in the device category taking shortest time to execute the specified task based on the GPU of the representative device.

The category determination module 404 is configured to determine a target device category to which the target device belongs based on the configuration file.

The task execution module 406 is configured to execute the specified task by using the preferred GPU sub-thread number corresponding to the target device category.

The above apparatus of the embodiment of the present disclosure can obtain a configuration file that is recorded with the mapping relationship between a device category and a preferred GPU sub-thread number when executing a specified task, and execute the specified task by using a preferred GPU sub-thread number corresponding to a target device category to which a target device belongs, the preferred GPU sub-thread number corresponding to the target device category being a GPU sub-thread number used by a representative device in the device category to execute the specified task with the shortest time. Due to devices in the same device category usually have a commonality, the time required for the target device to execute the task using the preferred GPU sub-thread number corresponding to the representative device in the device category is usually shorter. Compared to a default GPU sub-thread number, the above method is easy to implement and can effectively improve task execution effect.

In some embodiments, the configuration file is recorded with device identifiers of a plurality of devices corresponding to each device category; and the category determination module is configured to search for the device category corresponding to a device identifier of the target device in the configuration file, and use the device category searched as the target device category to which the target device belongs.

In some embodiments, the configuration file is recorded with a categorization method of the device category, the categorization method comprising categorization by a GPU manufacturer name or categorization by a GPU model; and the category determination module is configured to determine the target device category to which the target device belongs based on the categorization method of the device category recorded in the configuration file and GPU information of the target device.

In some embodiments, the GPU information comprises the GPU manufacturer name or the GPU model.

In some embodiments, all devices corresponding to each device category have a specific GPU commonality, and different device categories correspond to different GPU commonalities.

In some embodiments, the apparatus further comprises a file generation module configured to: obtain GPU information of a plurality of devices, wherein each of the plurality of devices is configured with a GPU; categorize the plurality of devices into a plurality of device categories based on the GPU information, each device category of the plurality of device categories corresponding to a plurality of devices; for the each device category, select a representative device from all devices corresponding to the each device category, obtain the preferred GPU sub-thread number corresponding to the representative device of the each device category, and use the preferred GPU sub-thread number as the preferred GPU sub-thread number corresponding to the each device category; and generate the configuration file based on the mapping relationship between the each device category and the preferred GPU sub-thread number.

In some embodiments, the file generation module is configured to: obtain a plurality of candidate GPU sub-thread numbers; for each of the plurality of candidate GPU sub-thread numbers, use the each of the plurality of candidate GPU sub-thread numbers as a parameter for a preset OpenCL program, and obtain time consumption for the representative device of the each device category to adopt the preset OpenCL program to execute the specified task; and use a candidate GPU sub-thread number corresponding to shortest time consumption as the preferred GPU sub-thread number corresponding to the representative device of the each device category. In some embodiments, the GPU information comprises a GPU manufacturer name. The file generation module is configured to categorize the plurality of devices into a plurality of manufacturer categories based on the GPU manufacturer name of each of the plurality of devices, wherein all devices corresponding to each of the plurality of manufacturer categories have a same manufacturer name.

In some embodiments, the GPU information comprises a GPU model. The file generation module is configured to categorize the plurality of devices into a plurality of GPU model categories based on the GPU model of each of the plurality of devices, wherein all devices corresponding to each of the plurality of GPU model categories have a same GPU model.

In some embodiments, the GPU information comprises a GPU manufacturer name or a GPU model; the file generation module is configured to: if the GPU information is the GPU manufacturer name, categorize the plurality of devices into a plurality of manufacturer categories based on the GPU manufacturer name of each of the plurality of devices, wherein all devices corresponding to each of the plurality of manufacturer categories have a same manufacturer name; if the GPU information is the GPU model, categorize the plurality of devices into a plurality of GPU model categories based on the GPU model of each of the plurality of devices, wherein all devices corresponding to each of the plurality of GPU model categories have a same GPU model.

In some embodiments, the file generation module is configured to: obtain index data of each of the plurality of devices corresponding to the each device category based on a preset measurement index, wherein the preset measurement index comprises a market coverage rate and/or device performance; and select the representative device from all the devices corresponding to the each device category based on the index data of the each of the plurality of devices.

In some embodiments, the file generation module is configured to select a most typical device from all the devices corresponding to the each device category as the representative device by comparing the index data of the plurality of devices.

In some embodiments, the file generation module is configured to: determine a median value of the index data of all the devices corresponding to the each device category based on the index data of the each of the plurality of devices; and select a device, of which index data is closest to the median value, from all the devices corresponding to the each device category, and use the device selected as the representative device of the each device category.

The task execution apparatus provided in the embodiment of the present disclosure can execute the task execution method provided in any embodiment of the present disclosure, and has functional modules corresponding to the execution method and the beneficial effect.

Those skilled in the art can clearly understand that, for the convenience and simplicity of description, for the specific working processes of the apparatus embodiments described above, reference can be made to the corresponding processes in the method embodiment, which will not be repeated here.

An embodiment of the present disclosure further provides an electronic device, comprising: a processor; and a memory configured to store executable instructions for the processor; wherein the processor is configured to read the executable instructions from the memory and execute the executable instructions to implement the task execution method described above.

FIG. 5 is a schematic structure diagram of an electronic device provided by an embodiment of the present disclosure. As shown in FIG. 5, the electronic device 500 comprises one or more processors 501 and a memory 502.

The processor 501 may be a central processing unit (CPU) or a processing unit in other forms having data processing capability and/or instruction execution capability, and may control other components in the electronic device 500 to perform desired functions.

The memory 502 may comprise one or more computer program products, which may comprise various forms of computer-readable storage media, such as volatile memory and/or non-volatile memory. For example, the volatile memory may comprise random access memory (RAM) and/or cache memory or the like. For example, the non-volatile storage medium comprises read-only memory (ROM), hard disk, flash memory or the like. One or more computer program instructions can be stored on the computer-readable storage medium, and the processor 501 can execute the program instructions to realize the task execution method and/or other desired functions in the embodiments of the present disclosure described above. Various contents such as input signals, signal components, noise components and the like can also be stored in the computer-readable storage medium.

In an embodiment, the electronic device 500 may further comprise: an input device 503 and an output device 504, which are interconnected by a bus system and/or other form of connection mechanism (not shown).

In addition, the input device 503 may also comprise, for example, a keyboard, a mouse, or the like.

The output device 504 can output various information to the outside, comprising determined distance information, orientation information, or the like. The output device 504 may comprise, for example, a display, a speaker, a printer, a communication network, a remote output device connected thereto, or the like.

Of course, to simplify, only some components related to the present disclosure in the electronic device 500 are shown in FIG. 5, and components such as buses, input/output interfaces, and the like are omitted. In addition, depending on the specific application, the electronic device 500 may also comprise any other appropriate components.

In addition to the above methods and devices, an embodiment of the present disclosure can also be a computer program product, which comprises computer program instructions that, when executing by a processor, cause the processor to execute the task execution method provided in the embodiments of the present disclosure.

The computer program product can write program codes for performing the operations of the embodiments of the present disclosure in any combination of one or more program design languages, the program design languages comprising object-oriented program design languages, such as Java, C++, etc, as well as conventional procedural program design languages, such as “C” language or similar program design language. The program code may be completely or partly executed on a user device, or executed as an independent software package, partly executed on the user device and partly executed on a remote computing device, or completely executed on a remote computing device or server.

In addition, an embodiment of the present disclosure can also be a computer readable storage medium (e.g., a non-transitory computer-readable medium) having stored thereon computer program instructions that, when executed by a processor, cause the processor to perform the task execution method provided in the embodiments of the present disclosure.

The computer readable storage medium can employ any combination of one or more readable media. The readable medium can be a readable signal medium or a readable storage medium. The readable storage medium can comprise, for example, but not limited to, an electronic, magnetic, optical, electromagnetic, infrared, or semiconductor system, apparatus, or device, or any combination of the above. More specific examples (non-exhaustive lists) of readable storage media comprise: electrical connection with one or more wires, portable disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing.

An embodiment of the present disclosure further provides a computer program product containing a computer program or instructions that, when executed by a processor, implement the task execution method in the embodiments of the present disclosure.

An embodiment of the present disclosure further provides a computer program, comprising: instructions that, when executed by a processor, cause the processor to perform the task execution method in the embodiments of the present disclosure.

It should be noted that in the description, the use of relational terms such as “first” and “second” and the like are used solely to distinguish one entity or action from another entity or action without necessarily requiring or implying any actual such relationship or order between such entities or actions. Further, terms “comprise”, “include” or their any other variations are intended to encompass non-exclusive inclusion, so that a process, method, product or device comprising a series of factors may comprise not only these factors, but also other factors that are not listed explicitly, or factors intrinsic to this process, method, product or device. Without further limitation, a factor defined by wording “comprise one . . . ” does not exclude the existence of other same factors in a process, method, product or device comprising such factor.

The above descriptions are only specific embodiments of the present disclosure, so that those skilled in the art can understand or implement the present disclosure. Various modifications to these embodiments will be apparent to those skilled in the art, and the generic principles defined herein may be implemented in other embodiments without departing from the spirit or scope of the present disclosure. Accordingly, the present disclosure should not be limited to the embodiments described herein, but should be accorded the broadest scope consistent with the principles and novel features disclosed herein.

1. A task execution method applied to a target device configured with a graphics processing unit (GPU), the task execution method comprising:
obtaining a configuration file in response to receiving an execution instruction for a specified task, wherein the specified task is a task executed based on the GPU, and the configuration file comprises a mapping relationship between a device category and a preferred GPU sub-thread number, wherein the preferred GPU sub-thread number is number of a sub-thread of the GPU used by a representative device in the device category taking shortest time to execute the specified task based on the GPU of the representative device;
determining a target device category to which the target device belongs based on the configuration file; and
executing the specified task by using the preferred GPU sub-thread number corresponding to the target device category.

2. The task execution method according to claim 1, wherein the configuration file is recorded with device identifiers of a plurality of devices corresponding to each device category; and
the determining of the target device category to which the target device belongs based on the configuration file comprises:
searching for the device category corresponding to a device identifier of the target device in the configuration file, and using the device category searched as the target device category to which the target device belongs.

3. The task execution method according to claim 1, wherein the configuration file is recorded with a categorization method of the device category, the categorization method comprising categorization by a GPU manufacturer name or categorization by a GPU model; and
the determining of the target device category to which the target device belongs based on the configuration file comprises:
determining the target device category to which the target device belongs based on the categorization method of the device category recorded in the configuration file and GPU information of the target device.

4. The task execution method according to claim 3, wherein the GPU information comprises the GPU manufacturer name or the GPU model.

5. The task execution method according to claim 1, wherein all devices corresponding to a device category have a specific GPU commonality, and different device categories correspond to different GPU commonalities.

6. The task execution method according to claim 1, wherein the configuration file is generated by:
obtaining GPU information of a plurality of devices, wherein each of the plurality of devices is configured with a GPU;
categorizing the plurality of devices into a plurality of device categories based on the GPU information, each device category of the plurality of device categories corresponding to a plurality of devices;
for the each device category, selecting a representative device from all devices corresponding to the each device category, obtaining the preferred GPU sub-thread number corresponding to the representative device of the each device category, and using the preferred GPU sub-thread number as the preferred GPU sub-thread number corresponding to the each device category; and
generating the configuration file based on the mapping relationship between the each device category and the preferred GPU sub-thread number.

7. The task execution method according to claim 6, the obtaining of the preferred GPU sub-thread number corresponding to the representative device of the each device category comprises:
obtaining a plurality of candidate GPU sub-thread numbers;
for each of the plurality of candidate GPU sub-thread numbers, using the each of the plurality of candidate GPU sub-thread numbers as a parameter for a preset open computing language OpenCL program, and obtaining time consumption for the representative device of the each device category to adopt the preset OpenCL program to execute the specified task; and
using a candidate GPU sub-thread number corresponding to shortest time consumption as the preferred GPU sub-thread number corresponding to the representative device of the each device category.

8. The task execution method according to claim 6, wherein the GPU information comprises a GPU manufacturer name; and
the categorizing of the plurality of devices into the plurality of device categories based on the GPU information comprises: categorizing the plurality of devices into a plurality of manufacturer categories based on the GPU manufacturer name of each of the plurality of devices, wherein all devices corresponding to each of the plurality of manufacturer categories have a same manufacturer name.

9. The task execution method according to claim 6, wherein the GPU information comprises a GPU model; and
the categorizing of the plurality of devices into the plurality of device categories based on the GPU information comprises: categorizing the plurality of devices into a plurality of GPU model categories based on the GPU model of each of the plurality of devices, wherein all devices corresponding to each of the plurality of GPU model categories have a same GPU model.

10. The task execution method according to claim 6, wherein the selecting of the representative device from all devices corresponding to the each device category comprises:
obtaining index data of each of the plurality of devices corresponding to the each device category based on a preset measurement index, wherein the preset measurement index comprises a market coverage rate and/or device performance; and
selecting the representative device from all the devices corresponding to the each device category based on the index data of the each of the plurality of devices.

11. The task execution method according to claim 10, wherein the selecting of the representative device from all the devices corresponding to the each device category based on the index data of the each of the plurality of devices comprises: selecting a most typical device from all the devices corresponding to the each device category as the representative device by comparing the index data of the plurality of devices.

12. The task execution method according to claim 10, wherein the selecting of the representative device from all the devices corresponding to the each device category based on the index data of the each of the plurality of devices comprises:
determining a median value of the index data of all the devices corresponding to the each device category based on the index data of the each of the plurality of devices; and
selecting a device, of which index data is closest to the median value, from all the devices corresponding to the each device category, and using the device selected as the representative device of the each device category.

13. (canceled)

14. An electronic device applied to a target device configured with a graphics processing unit (GPU), comprising:
a processor; and
a memory configured to store executable instructions for the processor;
wherein the processor is configured to read the executable instructions from the memory and execute the executable instructions to:
obtain a configuration file in response to receiving an execution instruction for a specified task, wherein the specified task is a task executed based on the GPU, and the configuration file comprises a mapping relationship between a device category and a preferred GPU sub-thread number, wherein the preferred GPU sub-thread number is number of a sub-thread of the GPU used by a representative device in the device category taking shortest time to execute the specified task based on the GPU of the representative device;
determine a target device category to which the target device belongs based on the configuration file; and
execute the specified task by using the preferred GPU sub-thread number corresponding to the target device category.

15. A non-transitory computer-readable storage medium on which a computer program is stored, wherein the non-transitory computer-readable storage medium is applied to a target device configured with a graphics processing unit (GPU), and the computer program is configured to:
obtain a configuration file in response to receiving an execution instruction for a specified task, wherein the specified task is a task executed based on the GPU, and the configuration file comprises a mapping relationship between a device category and a preferred GPU sub-thread number, wherein the preferred GPU sub-thread number is number of a sub-thread of the GPU used by a representative device in the device category taking shortest time to execute the specified task based on the GPU of the representative device;
determine a target device category to which the target device belongs based on the configuration file; and
execute the specified task by using the preferred GPU sub-thread number corresponding to the target device category.

16. (canceled)

17. The electronic device according to claim 14, wherein the configuration file is recorded with device identifiers of a plurality of devices corresponding to each device category; and
the processor is configured to read the executable instructions from the memory and execute the executable instructions to search for the device category corresponding to a device identifier of the target device in the configuration file, and use the device category searched as the target device category to which the target device belongs.

18. The electronic device according to claim 14, wherein the configuration file is recorded with a categorization method of the device category, the categorization method comprising categorization by a GPU manufacturer name or categorization by a GPU model; and
the processor is configured to read the executable instructions from the memory and execute the executable instructions to determine the target device category to which the target device belongs based on the categorization method of the device category recorded in the configuration file and GPU information of the target device.

19. The electronic device according to claim 18, wherein the GPU information comprises the GPU manufacturer name or the GPU model.

20. The non-transitory computer-readable storage medium according to claim 15, wherein the configuration file is recorded with device identifiers of a plurality of devices corresponding to each device category; and
the computer program is configured to search for the device category corresponding to a device identifier of the target device in the configuration file, and use the device category searched as the target device category to which the target device belongs.

21. The non-transitory computer-readable storage medium according to claim 15, wherein the configuration file is recorded with a categorization method of the device category, the categorization method comprising categorization by a GPU manufacturer name or categorization by a GPU model; and
the computer program is configured to determine the target device category to which the target device belongs based on the categorization method of the device category recorded in the configuration file and GPU information of the target device.

22. The non-transitory computer-readable storage medium according to claim 21, wherein the GPU information comprises the GPU manufacturer name or the GPU model.
